(19) United States
(12) Patent Application Publication
(10) Pub. No.: US 2008/0256576 A1
(43) Pub. Date: Oct. 16, 2008

(54) Method and Apparatus for Detecting Content Item Boundaries

(75) Inventors: Jan Alexis Daniel Nesvadba, Eindhoven (NL); Dzevdet Burazerovic, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/914,763

(22) PCT Filed: May 4, 2006
(86) PCT No.: PCT/IB06/51403

§ 371 Date: Nov. 19, 2007

(30) Foreign Application Priority Data
May 19, 2005 (EP) 05104265.3

(51) Int. Cl. G06F 3/00

(52) U.S. Cl. 725/39

(57) ABSTRACT

The invention relates to a method of identifying a boundary (211, 212) of a content item in a content stream (201), the method comprising the steps of: (110) receiving predetermined additional data related to the content item, the additional data comprising attribute data describing substantially the whole content item, (130) using a content-analysis processor (310) for analyzing the content stream so as to detect whether the content stream corresponds to the attribute data, and (140) identifying the boundary of the content item in the content stream when the correspondence changes from valid to invalid, or vice versa. The attribute data may indicate a genre of a movie, a music style of a song, etc. or a sequence of genres/music styles. The content-analysis processor (310) utilizes the attribute data to detect whether the content stream belongs to the content item by analyzing the content stream so as to detect the correspondence of the content stream to the attribute data.

The invention relates to a method of identifying a boundary of a content item in a content stream, an apparatus for identifying a boundary of a content item in a content stream, and a computer program product allowing implementation of the method or configuration of the apparatus.

WO02/100098 describes a method of detecting start and end times of a TV program. EPG data (Electronic Program Guide) indicate the start and end times of the program. Characteristic data are gathered from a video segment (video frames) of the program at the start time and at the end time. A first value (signature) representing the characteristic data is included in the EPG data.

When a user selects the program from an EPG catalog, a broadcast signal of a TV channel is monitored and a second value (signature) representing the characteristic data is determined from video data of the TV channel. When the first value matches the second value, a receiver detects the start time or the end time of the program.

The first value is generated from closed captioning data of one or more frames at the beginning/end of the program (trigger words), or low-level frame features, e.g. a block of DCT data or a color histogram of a start/end frame.

The method known from WO02/100098 requires the signatures to be additionally included into the EPG data. Traditionally, the EPG does not include such data, probably because broadcasters do not prefer to include such information in the broadcast EPG data. Hence, the traditional EPG data would not enable the method known from WO02/100098 to work. Moreover, the method is not reliable because it does not work if the monitoring of the broadcast signal is launched in the middle of the program and it is attempted to find the match from that point with the signature representative of the beginning of the TV program.

It is desirable to provide a method of identifying the boundary of the content item, which is more reliable and simpler than the method of WO02/100098.

The method of the present invention comprises the steps of:
receiving predetermined additional data related to the content item, the additional data comprising attribute data describing substantially the whole content item,
using a content-analysis processor for analyzing the content stream so as to detect whether the content stream corresponds to the attribute data, and
identifying the boundary of the content item in the content stream when the correspondence changes from valid to invalid, or vice versa.

The additional data comprising the attribute data may be incorporated in the content stream by a broadcaster, or obtained by a receiver independently of the content stream. The attribute data may indicate a genre (e.g. comedy, drama), topic (e.g. Olympic Games), format (e.g. movie, news) of the content item, or any other information which characterizes substantially the whole content item differently from other content items, possibly present in the content stream.

WO02/100098 requires two signatures to be provided so as to determine the boundaries of the content item. In contrast, only one data is required in the present invention, so as to save transmission channel bandwidth and avoid unnecessary data in the content stream. Moreover, such signatures have to be computed at a broadcaster side that requires additional data-processing equipment, whereas the additional data as used in the present invention may simply be a text data included into the content stream.

The content stream is analyzed so that the attribute data is detected or not detected. For example, audio/video characteristic data associated with specific attribute data are monitored in the content stream. For instance, content items of a particular genre often have common audio/video characteristics. If the specific audio/video characteristics are identified in the content stream, then the corresponding part of the content stream belongs to the content item.

When there is a transition between a correspondence of the content stream to the attribute data and termination of the correspondence, or vice versa, the boundary of the content item is considered to be detected.

The apparatus of the present invention comprises a content-analysis processor for:
receiving predetermined additional data related to the content item, the additional data comprising attribute data describing substantially the whole content item,
analyzing the content stream so as to detect whether the content stream corresponds to the attribute data, and
identifying the boundary of the content item in the content stream when the correspondence changes from valid to invalid, or vice versa.

The apparatus functions in accordance with the method of the present invention.

These and other aspects of the invention will be further explained and described, by way of example, with reference to the following drawings:

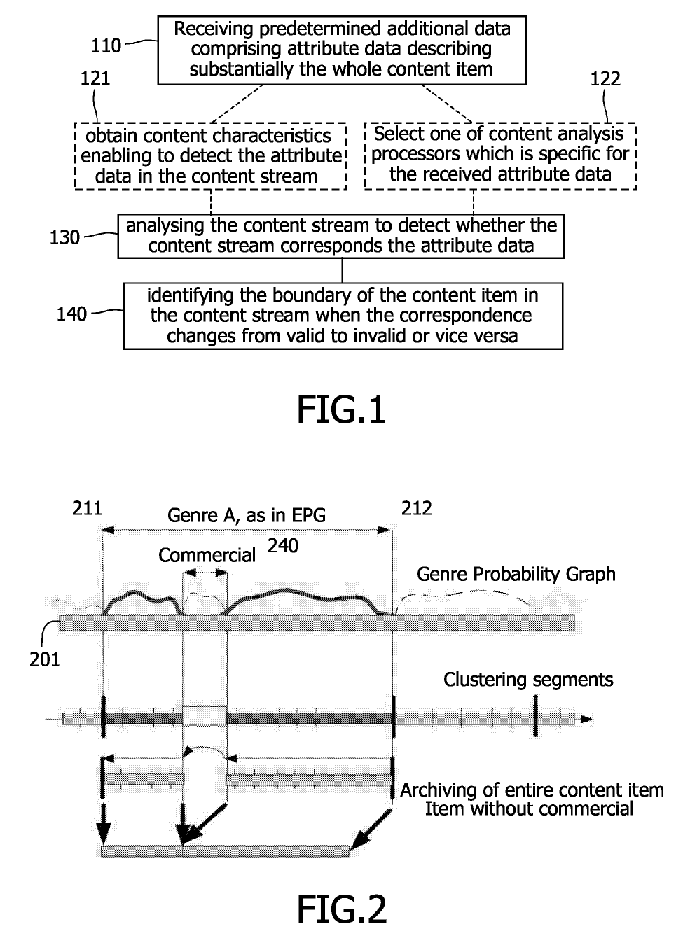

FIG. 1 shows an embodiment of the method of the present invention;

FIG. 2 is a time diagram, wherein the detection of a boundary of the content item in the content stream is shown, using a content-analysis algorithm and e.g. EPG data (or other service data) indicating a genre of the content item; and

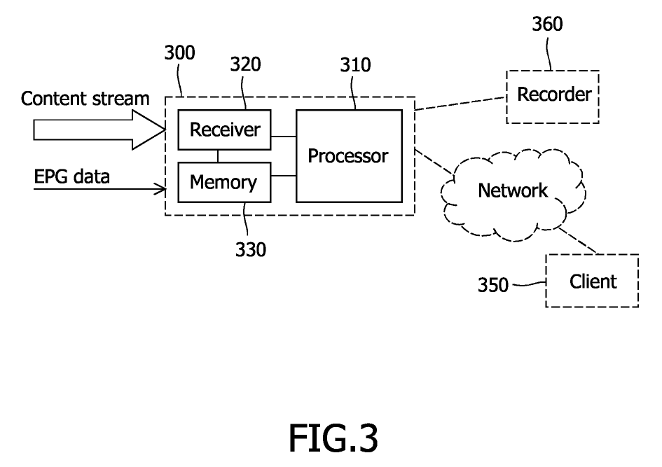

FIG. 3 is a functional block diagram of an embodiment of the apparatus according to the present invention.

Media content broadcasters supplement broadcast content items, e.g. TV programs, with additional data, such as EPG data that often comprises a genre of the program, a name of a TV anchorman or reporter. As another example, film studios produce movies that are supplemented with a list of actors starring in a respective movie.

A content stream may be a broadcast television signal or a recovered video signal from a DVD disk, etc. but no boundaries of a content item are indicated, in which a user is interested or which are important to identify so as to store or retrieve the content item. Alternatively, the boundaries of the content item may not be accessible, e.g. in view of a format or means by which the boundaries are marked in the content stream (e.g. unreadable encrypted boundary data).

In the present invention, additional information about the content item is utilized in order to identify a start boundary and/or end boundary of the content item. The additional data, e.g. the EPG data or other service data, comprises attribute data describing substantially the whole content item. For instance, it is common practice to include a type of genre of a TV program in the EPG data. However, the genre type does not necessarily need to be pre-incorporated in the content stream, but the type of genre of a specific content item may be found out, e.g. by using a title of the specific content item pre-incorporated in the content stream, e.g. by searching on the Internet.

It is advantageous to use such attribute data because this data describes any part or most of the content item. Therefore, the content analysis process may be started from substantially any part of the content item, i.e. inside the content item or beyond the content item in the content stream.

FIG. 1 shows an embodiment of a method of the present invention. In step 110, the additional data, as incorporated by the broadcaster, producer or other service provider into the content stream, is received at a receiving side. The additional data comprises the attribute data which describes the content item so that substantially any part of the content item corresponds to this description. For instance, if the attribute data indicates that the content item is classified as drama, most of the content item will comply with such a description.

It is possible that the content item has parts of different genres. In this case, the content of the item may be difficult to describe by means of a single catchword. For instance, a movie may begin with gloomy scenes but gradually evolve into a cheerful end. In other words, different patterns of changing genres may occur in the content item. In one embodiment, the genre pattern of a particular content item is included into the attribute data or obtainable by using the attribute data. For instance, in line with a sequence of the genres in the content item, the broadcaster includes a list of keywords associated with this genre sequence into the attribute data. Instead of one genre keyword, as is usually included in the known EPG data by the broadcasters, a sequence of the keywords may be included. In that manner, the content item is described more precisely and reliably by the attribute data in the case of the content item with multiple genres. Of course, the above embodiment may be extended to the attribute data describing not only the genres but also other classification types, e.g. music styles.

The attribute data may be in any format, and not necessarily as text keywords. For instance, the broadcaster includes digital codes, e.g. numbers of the genres, for the content item in the content stream. The codes may be not meaningful as such, but merely serve as indices in a classification scheme of the broadcaster for content items.

The genre or other classification value indicated in the attribute data may not be helpful as such to determine whether the content stream corresponds to this description, e.g. when the attribute data is merely a text data like sports, news, weather forecast, etc. There are various ways of detecting the correspondence of the content stream to the attribute data. For instance, two possible approaches are explained with reference to steps 121 and 122.

In one example, it is attempted to use the attribute data to obtain information about text/audio/video characteristics of a content which would comply with the specific description (e.g. the type of genre) indicated in the attribute data. In step 121, the content-analysis processor is configured to obtain content characteristic data associated with a specific type of the attribute data. The content characteristic data should be such as to enable the processor to determine whether the content stream corresponds to the specific type/value of the attribute data. For instance, in the case of the attribute data indicating an actor's name dominating in (a specific part of) the content item, the processor obtains e.g. speech characteristics or face biometrics (images) of the actor. Such information may be downloaded from specialized databases or the Internet.

In a second example, there may be one or more content-analysis processors specifically adapted to detect the correspondence of the content stream to a (respective) specific type of the attribute data. In step 122, it is determined whether there is any content-analysis processor which is suitable to detect the correspondence of the content stream to the specific type of the attribute data. One of the processors which is determined as suitable is automatically selected and the analysis of the content stream is started. For instance, a set of genre detectors (content-analysis processors) may be mapped on corresponding genres. For the specific genre as indicated in the attribute data, a respective genre detector is initiated for the content analysis of the content stream. For example, a method of cartoon detection is known from WO03010715, and a method of commercial block detection is known from WO02093929.

In step 130, the content stream is analyzed by the content-analysis processor so as to detect whether the content stream corresponds to the attribute data. For instance, a specific genre detector is utilized to detect the correspondence or a mismatch.

When the content-analysis processor detects a transition from a match to a mismatch (or vice versa) with the attribute data in step 140, a boundary of the content item in the corresponding portion of the content stream is considered to be identified.

In one embodiment of the method, a content-analysis processor is first used to autonomously determine a current genre of the content stream independently of the predetermined genre indicated in the attribute data. The current genre may be compared with the pre-determined genre, and the match or mismatch may be determined. In this embodiment, the content analysis processor is not instructed in advance about a type of genre of the content item to be found in the content stream. Therefore, it may be required to check one after another whether a particular one of possible genres is present in the content stream. Thus, this embodiment may be slower than when the content-analysis processor is instructed beforehand about the specific, sought genre.

FIG. 2 is a time diagram indicating a first boundary 211 and a second boundary 212 of the content item in the content stream 201. In this embodiment, the content analysis processor is designed to discriminate the content stream in conformance with the attribute data. The processor continuously outputs a confidence or probability value indicating a degree of conformance of the content stream to the pre-specified attribute data. For instance, the probability value relates to a percentage of video frames in a video stream with video characteristics in accordance with the specific genre type. When the probability value falls below a pre-determined threshold value, the boundary of the content item is identified.

The content analysis processor effectively generates the confidence value for each subsequent frame of the content item (video frame). For example, the confidence value may range between 0 and 1, with 1 indicating the certainty of a frame belonging to a video genre being identified. A system delivering such a content identification is disclosed in e.g. WO2004019527. Signatures are used that comprise averages of multiple audiovisual features taken from each frame of the content item.

Any number of consecutive confidence values, comprised within a time window of specific length, may be inspected with regard to its consistency in exceeding a threshold for positive identification of a specific genre. For instance, if, say, at least 80% of all the confidence values within the window of 20 seconds exceed the value of 0.5, the entire window is designated as belonging to the same genre. Otherwise a change of genre, starting with that window, is signaled. All of these parameters—window length and detection threshold and the percentage for the confidence values are only examples; they may be adjusted differently regarding the particularities of a given genre (also including the capabilities of the analysis processor of identifying that genre). Moreover, the genre-identification results obtained for a number of subsequent windows may be taken to produce a coarser identification pattern that can be inspected on its consistency in a similar fashion.

Multiple confidence values may also be generated at the same time, each indicating a probability of a different genre. In that case, a change from genre A to genre B may be simply established as the location where the positive identification of genre B coincides with the negative identification of genre B, with both identifications in accordance with the procedure described above.

Optionally, before the content-analysis processor is used to check the correspondence of the content stream to the attribute data, the content stream is pre-processed so as to verify whether any commercial break occurs. Known commercial detection methods may be used to detect the commercial breaks. For example, a commercial insert 240 is detected in the content stream between the start and end positions. A part of the content stream, where the commercial insert is found, may be of no interest for the further content analysis. Therefore, the part of the commercial insert may be excluded from the further content analysis (additionally, certain areas around the commercial insert may be marked as “forbidden areas” for the further content analysis). For example, one of the suitable commercial detection methods is described in WO02093929.

If the content-analysis processor detects the correspondence of the content stream to the attribute data, the content-analysis processor may start clustering content blocks of the content stream. The content block may be a video shot or a video scene. The video shot is usually composed of consecutive video frames appearing to be defined by a single camera act. Boundaries between video shots in the content stream may be determined e.g. as places (video frames) where visual parameters, e.g. motion vectors, change from a stationary to a more scattered behavior. A method of shot-cut detection is known from WO2004075537. The clustering technique of the video shots is known from e.g. an article by Dirk Farin, Wolfgang Effelsberg, Peter H. N. de With, “Robust Clustering-Based Video-Summarization with Integration of Domain-Knowledge”, IEEE International Conference on Multimedia and Expo, 1, pp. 89-92, Lausanne, Switzerland, August 2002. The video scene may correspond to a sequence (cluster) of contiguous video shots, possibly correlated by audio. A scene boundary may be detected as the simultaneous occurrence of the shot boundary and an audio silence break (audio silence of a certain duration) or any other audio transition. The clustering of the video scenes may be derived from an article by J. Nesvadba, N. Louis, J. Benois-Pineau, M. Desainte-Catherine and M. Klein Middelink, “Low-level cross-media statistical approach for semantic partitioning of audio-visual content in a home multimedia environment”, Proc. IEEE IWSSIP'04 (Int. Workshop on Systems, Signals and Image Processing), pp. 235-238, Poznan, Poland, Sep. 13-15, 2004.

FIG. 3 shows an embodiment of an apparatus 300 of the present invention. The apparatus 300 comprises a (digital data) processor 310 for analyzing the content stream (i.e. the content analysis processor), and, optionally, a receiver 320 and a memory unit 330.

The receiver 320 is arranged to receive the content stream, e.g. digital television signals or digital video signals, from the Internet as known in video on demand systems, Internet radio networks, etc. The receiver 320 may also be arranged to obtain the additional data, e.g. EPG data, comprising the attribute data. The memory unit 330 is arranged to store the content stream and/or the attribute data, which is accessible to the processor 310. The memory unit may be a known RAM (random access memory) memory module, a computer hard disk drive or another storage device.

The processor 310 is arranged to obtain the predetermined attribute data describing substantially the whole content item. As has been explained with reference to the method, the attribute data may indicate the genre of the movie, the music style of a song, etc. or the sequence of the genres/music styles. The processor 310 utilizes the attribute data to detect whether the content stream belongs to the content item by analyzing the content stream so as to detect the correspondence of the content stream to the attribute data. The content stream to be analyzed may be accessed by the processor 310 from the memory unit 330 serving as a buffer.

The processor 310 may be a central processing unit (CPU) suitably arranged to implement the present invention and enable the operation of the apparatus as explained above with reference to the method. The processor 310 may be configured to read at least one instruction from the memory unit 330 so as to enable the operation of the apparatus.

The apparatus 300 may be arranged to include tags of content item boundaries in the content stream and e.g. re-transmit the content stream to a remote client device 350, e.g. via a data network to a TV set or a portable PC. Hence, the apparatus may be incorporated in service provider equipment (content processing server), e.g. of a television cable provider.

Alternatively, the content stream with the tags may be communicated to a recorder 360 coupled to the apparatus 300. In other words, the apparatus may be implemented in any consumer electronics device (or multipurpose platform/device) such as a television set (TV set) with a cable, satellite or other link; a videocassette or HDD recorder or player, an audio player, a home cinema system, a remote control device such as an iPronto remote control, etc.

Variations and modifications of the described embodiment are possible within the scope of the inventive concept. For example, the content stream may be an audio content stream and suitable audio content analysis methods may be applied for the purposes of the present invention. In another example, the broadcaster maintains a database of the types of the attribute data, and corresponding codes. Only the codes may be included into the additional data incorporated in the content stream. The apparatus may access the database to obtain the attribute data (and even more detailed information) corresponding to the code or codes.

The content item may comprise at least one of, or any combination of, visual information (e.g. video images, photos, graphics) and audio information. The expression “audio information”, or “audio content”, is hereinafter used as data pertaining to audio comprising audible tones, silence, speech, music, tranquility, external noise or the like. The audio information may be in formats like the MPEG-1 layer II (mp3) standard (Moving Picture Experts Group), AVI (Audio Video Interleave) format, WMA (Windows Media Audio) format, etc. The expression “video information”, or “video content”, is used as data which are visible such as a motion picture, “still pictures”, video text, etc. The video data may be in formats like GIF (Graphic Interchange Format), JPEG (named after the Joint Photographic Experts Group), MPEG-4, etc.

The content stream may be obtained in any way, for example, in the form of a digital television signal (e.g. in one of the Digital Video Broadcasting formats) received via satellite, terrestrial, cable, Internet (streaming, Video On Demand, peer-to-peer) or another link.

The processor may execute a software program to enable the execution of the steps of the method of the present invention. The software may enable the apparatus of the present invention independently of where it is being run. To enable the apparatus, the processor may transmit the software program to the other (external) devices, for example. The independent method claim and the computer program product claim may be used to protect the invention when the software is manufactured or exploited for running on the consumer electronics products. The external device may be connected to the processor using existing technologies, such as Blue-tooth, IEEE 802.11[a-g], etc. The processor may interact with the external device in accordance with the UPnP (Universal Plug and Play) standard.

A “computer program” is to be understood to mean any software product stored on a computer-readable medium, such as a floppy disk, downloadable via a network, such as the Internet, or marketable in any other manner.

The various program products may implement the functions of the system and method of the present invention and may be combined in several ways with the hardware or located in different devices. The invention can be implemented by means of hardware comprising several distinct elements, and by means of a suitably programmed computer.

1. A method of identifying a boundary (211, 212) of a content item in a content stream (201), the method comprising the steps of:
(110) receiving predetermined additional data related to the content item, the additional data comprising attribute data describing substantially the whole content item,
(130) using a content-analysis processor (310) for analyzing the content stream so as to detect whether the content stream corresponds to the attribute data, and
(140) identifying the boundary of the content item in the content stream when the correspondence changes from valid to invalid, or vice versa.

2. The method of claim 1, wherein the additional data is an EPG data.

3. The method of claim 1, wherein the attribute data indicates a sequence of genres of the content item.

4. The method of claim 1, wherein the content-analysis processor is specifically adapted to detect the correspondence of the content stream only to a specific type of the attribute data.

5. The method of claim 1, wherein the content-analysis processor is configured to obtain content characteristic data associated with a specific type of the attribute data, and the content characteristic data enable the content-analysis processor to determine whether the content stream corresponds to the specific type of the attribute data when the content stream is analyzed.

6. The method of claim 1, further comprising a step of clustering content blocks in the content stream if the content blocks correspond to the attribute data.

7. An apparatus (300) for identifying a boundary (211, 212) of a content item in a content stream (201), the apparatus comprising a content-analysis processor (310) for:
receiving predetermined additional data related to the content item, the additional data comprising attribute data describing substantially the whole content item,
analyzing the content stream so as to detect whether the content stream corresponds to the attribute data, and
identifying the boundary of the content item in the content stream when the correspondence changes from valid to invalid, or vice versa.

8. The apparatus of claim 7, wherein the content-analysis processor is specifically adapted to detect the correspondence of the content stream only to a specific type of the attribute data.

9. The apparatus of claim 7, wherein the content-analysis processor is configured to obtain content characteristic data associated with a specific type of the attribute data, and to use the content characteristic data so as to determine whether the content stream corresponds to the specific type of the attribute data when the content stream is analyzed.

10. The apparatus of claim 8, wherein the content-analysis processor is configured to cluster content blocks in the content stream if the content blocks correspond to the attribute data.

11. A device selected from a video or audio-recorder, a video or audio-player and a content-processing server, comprising an apparatus as claimed in claim 7.

12. A computer program product enabling a programmable device, when executing a computer program of said product, to implement the method of claim 1.
